(19) United States
(12) Patent Application Publication
(10) Pub. No.: US 2011/0161340 A1
(43) Pub. Date: Jun. 30, 2011

(54) LONG-TERM QUERY REFINEMENT SYSTEM

(75) Inventors: Scott McCloskey, Minneapolis, MN (US); Ben Miller, Minneapolis, MN (US)

(73) Assignee: HONEYWELL INTERNATIONAL INC., Morristown, NJ (US)

(21) Appl. No.: 12/651,397

(22) Filed: Dec. 31, 2009

(51) Int. Cl. G06F 17/30

(52) U.S. Cl. 707/765; 707/769; 707/E17.014

(57) ABSTRACT

A system for providing long term query refinement. Low level information may be stored based on user feedback. There may be equivalence classes in an archive or memory which contain items from a query search which are labeled positive or negative by a user. Labels may be stored in class pairs over previously run queries. There may be propagation of labels to other items in the same or other classes. There may be a refinement which aids in changing the query to one that indicates more accurately what the user wants. A result set of items may be formulated from which a user may select a new query.

The U.S. Government may have certain rights in the present invention.

### BACKGROUND

The invention pertains to searching and particularly searching large databases. More particularly, the invention pertains to guided searches.

### SUMMARY

The invention is a system for providing long term query refinement. Low level information may be stored based on user feedback. There may be equivalence classes in an archive or memory which contain items from a query search which are labeled positive or negative by a user. Labels may be stored in class pairs over previously run queries. There may be propagation of labels to other items in the same or other classes. There may be a refinement which aids in changing the query to one that indicates more accurately what the user wants. A result set of items may be formulated from which a user may select a new query.

### BRIEF DESCRIPTION OF THE DRAWING

FIG. 1 is a diagram of a query refinement system;

FIG. 2 is a diagram of a system which is an extension of system of FIG. 1;

FIG. 3 is a diagram of various symbols which represent the various positive and negative results of queried items;

FIG. 4 is a diagram of a time table with searches performed in response to an inquiry;

FIG. 5 is a diagram showing contents that may be in a memory; and

FIG. 6 is a diagram with a spatial representation of various positive and negative results of a query.

### DESCRIPTION

Several commercial systems exist to help users search through large collections in order to retrieve those data that the user wishes to find. This is straightforward for certain types of data, e.g., searching for sales figures that meet certain criteria. However, searches for people, objects, or activities in large video archives are fraught with difficulties. Achieving good performance on clearly-specified searches, e.g., a search for all red cars in an archive, depends on the system's having good recognition performance on video, which is often beyond the state of the art. Achieving similar performance on more vaguely-specified, example-based searches introduces the additional difficulty of properly understanding the user's intent. If the example given by the user contains several objects, this raises the question as whether the intent is to find other instances of either object, both, or instances with a similar relationship between the two.

In order to resolve these issues, there may be many approaches in the realm of content-based image/video retrieval that employ user feedback to clarify user intent and help improve the recognition performance of the system. In many cases, possibly the simplest (and therefore easiest to provide) form of user feedback involves presenting the user with samples from the archive and asking that the user provide a positive/negative label for each, indicating whether or not they are accepted as correct. In order to have the system perform well, given relatively sparse input from the user, there are two fundamental questions that should be answered. A first question is which samples from the archive, if labeled by the user, enable the system to improve its performance the most. This question may be referred to as the active learning issue. A second question is, given a set of sparse labels, as provided by the user, how this information can be propagated to other, unlabeled, samples in the archive. This question may be referred to as the label propagation issue.

The present approach may address both the active learning and label propagation issues by employing a memory of user provided labels of the archive data. One may assume simple positive/negative labeling of samples, and further concentrate on example-based queries. For example-based queries, as mentioned previously, one of the difficulties is to determine from the input the user's intended search category. Due to uncertainty in this determination, it is not necessarily possible to assign a definitive, high-level label to archive data based on a user's feedback. For instance, one cannot necessarily assume that an archive sample is a red vehicle simply because the user has assigned it a positive label relative to an example video containing a red vehicle. The user may have intended to retrieve red objects more broadly, and the positively-labeled sample may be an image of an apple.

Because of the uncertainty inherent in example-based searching, one may design the system to store only low-level information based on user feedback. Here, one may retain a set of equivalence classes in the archive, where each equivalence class contains samples that were given the same label by the user with respect to a particular query. These equivalence classes may provide natural answers to both the active learning and label propagation issues.

For each query on which a user will provide feedback, one may generate two equivalence classes. One class may contain the set of samples that are positively labeled by the user, and another class may contain the negatively-labeled samples.

In subsequent queries, these equivalence classes may be used to solve the active learning issue. Elements chosen from each of the positively-labeled equivalence classes may provide much information when the elements are labeled in new queries. Thus, these elements get a high priority for labeling. If such an element is positively labeled in the new query, that positive label may be propagated to all other elements from its equivalence class and a negative label may be assigned to all elements of the corresponding negative equivalence class. If, on the other hand, the chosen element may be negatively labeled with respect to the new query, then the negative label can be propagated to the other elements of its equivalence class but no label can be assigned to the elements of the corresponding negative class.

Because of the difference between the two cases outlined, one may say that there is more information gained from getting a positive label on elements of positive equivalence classes. For this reason, when the system is able to get fewer labels from the user, the active learning approach will attempt to find elements of positive equivalence classes that are the best matches to the ongoing query, in order to improve the chances of getting the more valuable true (i.e., accurate) label. In addition, the sizes of the equivalence classes may also be taken into consideration, as it is more valuable when a label can be propagated to a larger set.

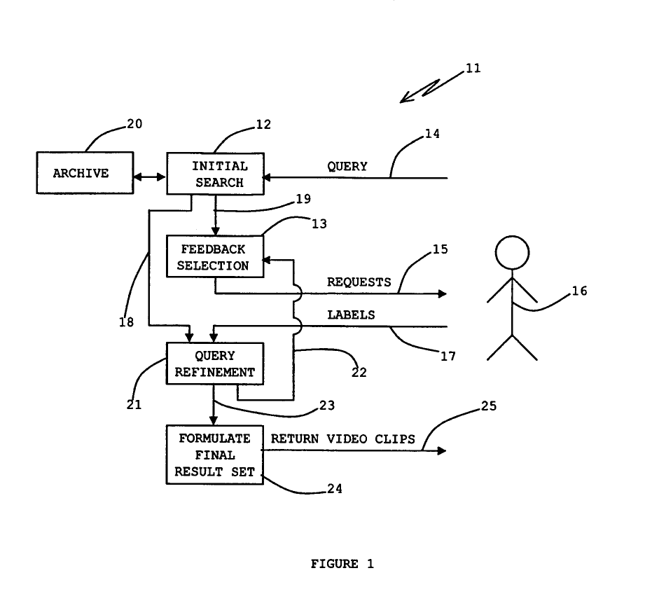

FIG. 1 is a diagram of a query refinement system 11. A query may be entered by a user 16 in an initial search module 12. The system may be illustrated with a specific example as a query; however, other kinds of items may be applied to the system. The medium for the present example may be video clips. A query at input 14 may be a search for all red cars in the archive at module 12. An output may be input on line 19 to a feedback selection module 13. A form of user feedback at feedback selection module 13 may involve presenting the user 16 at an output 15 with examples from the archive and be vested to provide a positive or negative label at input 17 for each example from the archive, indicating whether or not they are accepted as correct. A simple “positive” or “negative” labeling of the samples may be used relative to each example of a video clip. An output of the initial search module 12 may be entered at line 18 to a query refinement module 21. An output from query refinement module 21 may be fed back along a line 22 to feedback selection 13. Another output from query refinement module 21 may be fed along a line 23 to formulate a final result set module 24. An output 25 may return video clips from formulate find result set module 24 to a user 16.

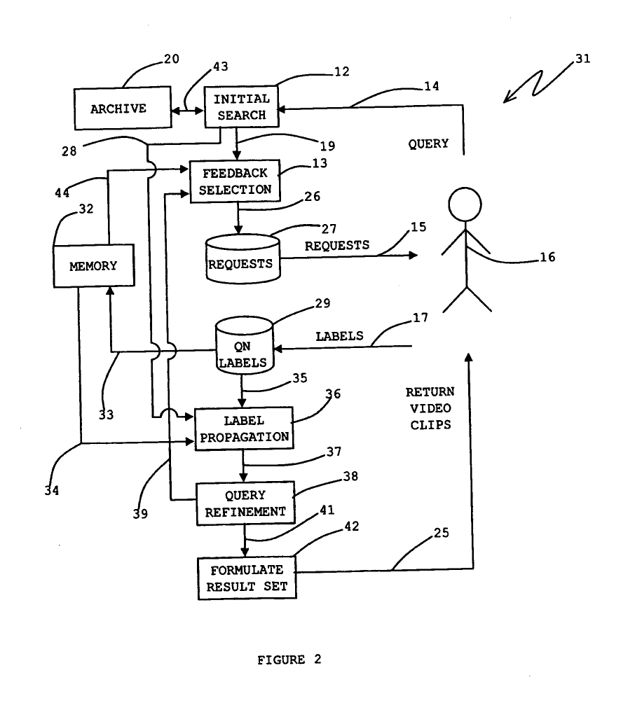

FIG. 2 is a diagram of a system 31 which may be an extension of system 11 of FIG. 1. A query may be entered at input 14 of an initial search module 12. The query may be, for example, a search for all red cars in an archive 20 connected via line 43 to module 12. An output of search matches may be input on a line 19 to a feedback selection module 13. An output on line 26 may include representative matches of search results from module 13 with requests asking for a positive or negative label for each match or representative match of search results from module 12. The requests may be fed into a database 27 along line 26 from module 13. Requests from database 27 may be provided to user 16 on a line 15. The requests to the user 16 may be associated or labeled with query labels which go to a query N(QN) database 29 via a line 17 by user 16. The labels may indicate for the matches or representative matches in accordance with requests from line 15 as to whether the respective match is correct or not, which may be indicated with a simple label of “positive” or “negative”. These labels may be placed in the QN database 29. The labels may be provided to a memory 32 along a line 33 from database 29. Information in memory 32 may be provided to feedback selection module 13 via line 44. The labels may be provided from label database 29 to a label propagation module 36 along a line 35. The matches or search results from search module 12 may go to the label propagation module 36 along line 28. Information from memory 32 may go to a label propagation module 36 via line 34. The propagation results, including found labels, of the labels from label propagation module 36 may go a query refinement module 38 via a line 37. Query refinements, including generation of a final result set, may proceed from module 38 to feedback selection module 13 for an iterative process along a line 39, and to a formulate result set module 42 along a line 41. A process of requests, labeling and label propagation may again cycle from module 13 through query refinement 38, including intermediate actions, to provide better query results as more information is fed into system 31 by user 16. Better label information may consequently be provided to memory 32 along line 33 from label database 29. With query refinement information from module 38 along line 41 to module 42, module 42 may cull out some of the items, and provide or return selected video clips on line 25 to user 16. The video clip results may be saved in an off-system file by user 16. If the user 16 decides to use one or more of the return video clips in a new query, then the selection of video clips may improve as the system 31 usage continues with better query and label information being made more accurate as inputs on lines 14 and 17, respectively. Or user 16 may begin the process of system 31 with an entirely new query on line 14.

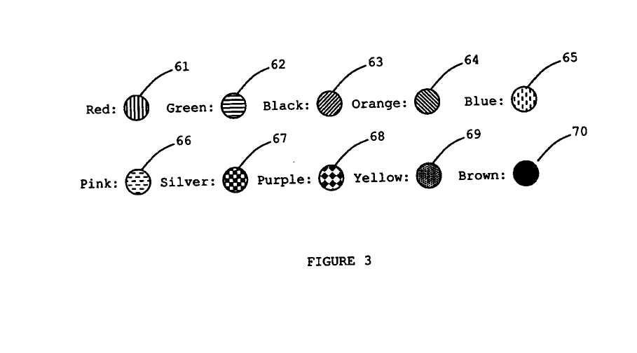

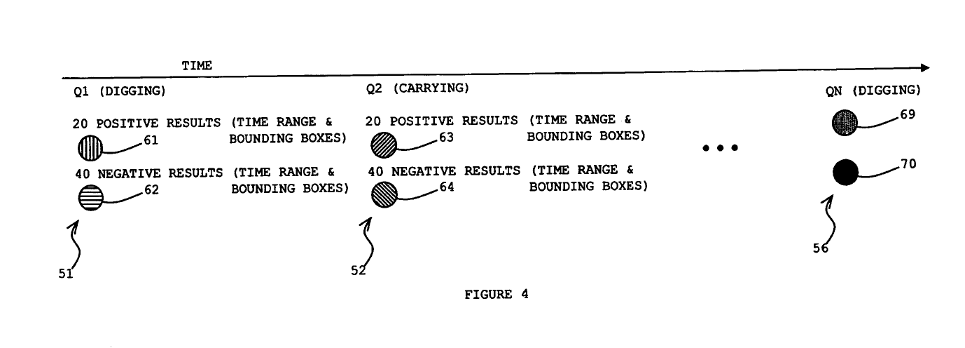

FIG. 3 shows the various symbols which may represent the various positive and negative results of the video clips discussed herein. FIG. 4 shows a time table with various searches done in response to a digging inquiry. In response, there may be an initial search with the query being an example video of people digging. The video may have other items in it such as cars driving by. The search may result in 60 video clip results. A request to a user may go out requesting the user to rate the results as positive or negative. The user may rate 20 results as positive and 40 results as negative. These ratings are associated with the results as labels which may be members of equivalence classes.

Another query, i.e., a video clip, may be entered which is labeled as carrying. The query may return 70 video clip results. The user, for instance, may rate 25 results as positive and 45 results as negative. The labels associated with the results may be provided to the database 29 by the user.

The 20 results of the digging rated as positive and the 40 results rated as negative may regarded as a positive equivalence class and a negative equivalence class, respectively. Queries may be regarded as Q1 (digging), Q2 (carrying) and so on to QN (digging). Each set of results may be regarded as having a time range and bounding boxes.

In FIG. 4, symbols 61 and 62 represent the positive and negative results, respectively, of the search for video 51. Symbols 63 and 64 represent the positive and negative results, respectively, of the search for video 52. Symbols 69 and 71 represent the positive and negative results, respectively, of the search for video 56.

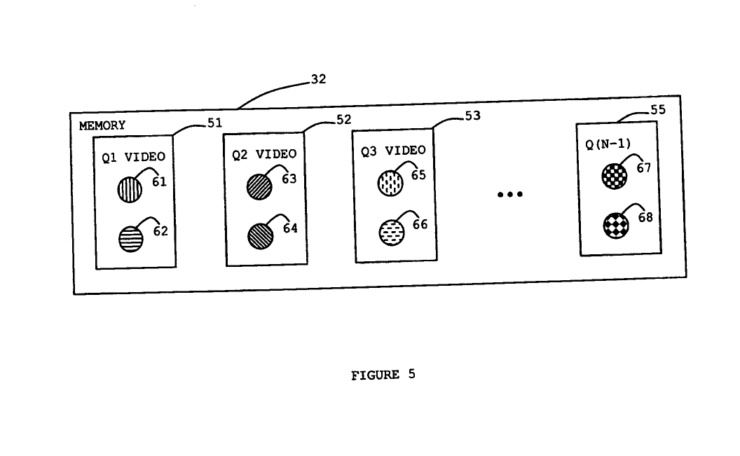

FIG. 5 shows a set of contents that might be in memory 32. In a similar sense, like the information shown in FIG. 4, there may be a Q1 video 51, Q2 video 52, Q3 video 53, and so on through Q(N−1) video 55. A QN video 56 would be the video currently being processed in system 31, as indicated in FIG. 4. The information in video clips 51, 52, 53 . . . 55 may include the video, the positive results, the negative results, and other related information. The circles may be coded such as to represent color, according to FIG. 3, and to distinguish them from other circles. Symbols 65 and 66 represent the positive and negative results, respectively, of the search for video 53. Symbols 67 and 68 represent the positive and negative results, respectively, of the search for video 55.

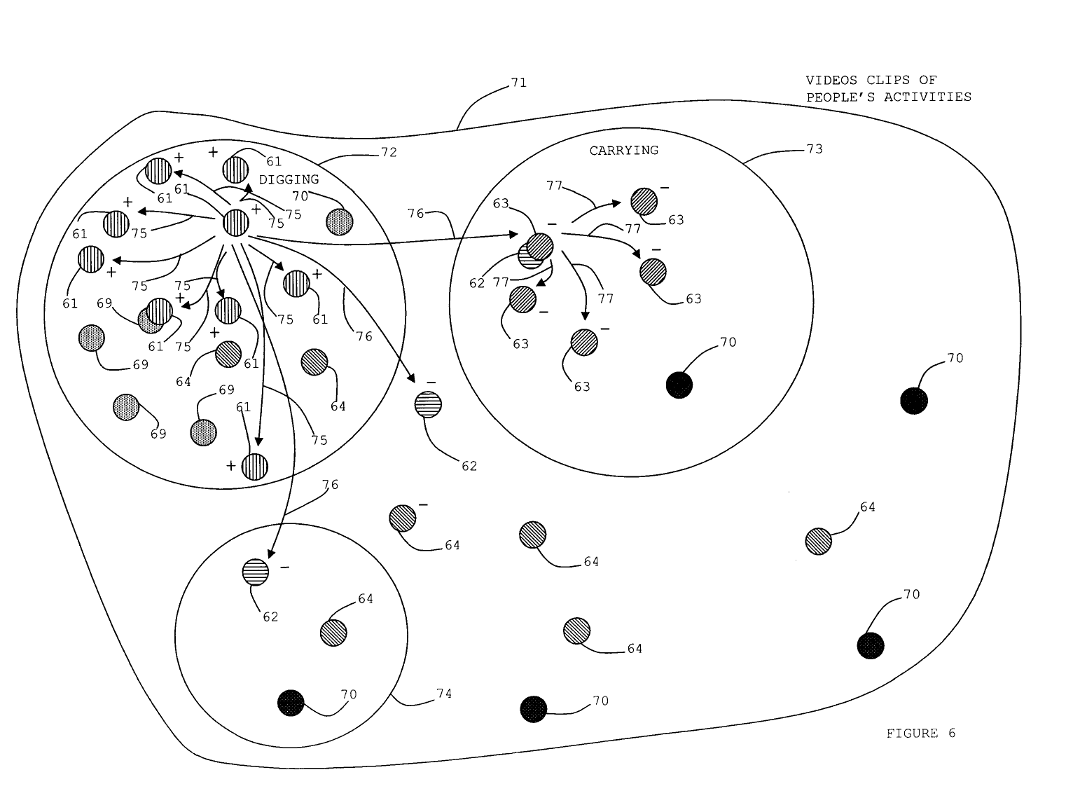

FIG. 6 is a diagram of various positive and negative results. In this Figure, the results of an inquiry may be noted in area 71. For instance, positive results 61 appear in an area 72 and are from the Q1 digging query 51. Numerous positive results 61 emanate from a central appearing positive result 61 as indicated by arrowed lines 75. Some negative results 62 appear outside of area 72. One result 62 appears in are 74. Another result 62 appears in no sub-area. The emanation of some of the negative results from the digging query 51 is indicated by arrowed lines 76.

One may note a negative result 62 proximate to a result 63 appears in area 73 with an emanation of positive results 63, as indicated by arrowed lines 77, for a carrying query 52. However, these results 63 may be negative relative to the digging query and have features which are similar to the negative results 62 of digging query 51 as indicated by result 62 emanated by an arrow 76 from area 72 to area 73.

The following is a recap of the present approach and system. The approach may be for querying with user input, with obtaining a query from a user, searching an archive for matches to the query, requesting the user to label the matches or elements from memory as positive if they resemble the query, requesting the user to label the matches or elements from memory as negative if they do not resemble the query, storing the matches and elements with labels in a memory, and selecting matches and elements using labels and the memory to formulate a result set.

This approach may also have a selection by the user of a match and/or element from the result set as a new query and a searching the archive for matches relative to the new query. Further, there may be a propagation of labels of matches, an obtaining a refined query from matches of propagated labels, a requesting the user to label some of the matches and/or elements from the memory as positive and regarded as refined matches and elements if they resemble the refined query, a requesting the user to label the refined matches or elements as negative if they do not resemble the refined query, storing the refined matches and elements with labels in a memory and selecting refined matches and elements labeled as positive for a result set. The approach additionally may have a selection of a refined match or element from the result set as a new query and a searching the archive for matches to the new query. A query may be a video clip and a match or element may be a video clip.

A query system may have a search mechanism for searching for elements in an archive that match a query from a user, a requester which asks the user to label at least some of the search/memory elements positive or negative if an element corresponds to the query or does not correspond to the query, respectively, a memory which receives from the user and stores the elements having positive and/or negative labels, and a selecting elements having labels from the memory to formulate a result set. The user may select an element from the result set or from the memory to be a new query, and the search mechanism may search for elements in the archive that match the new query.

The system may have a label propagator for propagating the labels of the elements having positive and/or negative labels and at times for finding new elements with corresponding labels, a query refiner for providing a match set of elements from the propagating of the labels of the elements, and a selector that chooses elements of the match set and a memory, for the user to label. The requestor may ask the user to label chosen elements as positive or negative if each one corresponds to the refined query or does not correspond to the refined query, respectively. The memory may receive from the user and store refined results having positive and/or negative labels, and the formulator may select certain refined results for a result set. The user may select a refined result from the result set as a new query. The search mechanism may search for results in the archive, which match the new query. A result or element may be a video clip and a query may be a video clip.

An approach may have a providing a query from a user, a performing a search in an archive to obtain results in response to the query, a providing the results to the user to indicate whether one or more results are responsive or not responsive to the query with a positive or negative label, respectively, a selecting at least one result with a positive label, an entering the at least one result with a positive label as an additional query in the archive to obtain another set of results in response to the additional query, a providing the other set of results to the user to indicate whether one or more results is responsive or not responsive to the additional query with a positive or negative label, respectively, and formulating a final result set which compromises results from the other set of results. The results with a negative label may be propagated to results of a corresponding negative equivalence class. Results with labels may be stored in a memory. The results with labels stored in the memory may provide information when the results are labeled in new queries. The results of the positive equivalence classes may be the best matches to ongoing queries to improve chances for getting a positive label. A result with a negative label may be assigned to results of a corresponding negative equivalence class. A query may be a video clip, and a result may be a video clip. Labels may be propagated to other unlabeled items in the archive. The approach may have a memory of user-provided labels of the archive data for additional queries, feedback selection of results, and/or label propagation.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A method for querying with user input, comprising:
obtaining a query from a user;
searching an archive for matches to the query;
requesting the user to label some of the matches and/or elements from the memory as positive if they resemble the query;
requesting the user to label the matches and/or elements from the memory as negative if they do not resemble the query;
storing the matches and elements with labels in a memory; and
selecting matches and elements using labels and the memory to formulate a result set.

2. The method of claim 1, further comprising:
a selection by the user of a match from the result set as a new query; and
searching the archive for matches relative to the new query.

3. The method of claim 1, further comprising:
propagation of labels of matches;
obtaining a refined query from matches of propagated labels;
requesting the user to label some of matches and/or elements from the memory as positive and regarded as refined matches and elements if they resemble the refined query;
requesting the user to label some of the matches and/or elements from the memory as negative if they do not resemble the refined query;
storing the refined matches and elements with labels in a memory; and
selecting refined matches and elements labeled as positive for a result set.

4. The method of claim 3, further comprising:
a selection of a refined match or element from the result set as a new query; and
searching the archive for matches to the new query.

5. The method of claim 4, wherein:
a query is a video clip; and
a match or element is a video clip.

6. A query system comprising:
a search mechanism for searching for elements in an archive that match a query from a user;
a requester which asks the user to label at least some of the elements from a search and/or a memory positive or negative if an element corresponds to the query or does not correspond to the query, respectively;
a memory which receives from the user and stores the elements having positive and/or negative labels; and
selecting elements having labels from the memory to formulate a result set.

7. The system of claim 6, wherein:
the user selects an element from the result set or from the memory to be a new query; and
the search mechanism searches for elements in the archive that match the new query.

8. The system of claim 7, further comprising:
a label propagator for propagating the labels of the elements having positive and/or negative labels and at times finding new elements with corresponding labels;
a query refiner for providing a match set of elements from the propagating of the labels of the elements; and
a selector that chooses elements of the match set and memory for the user to label; and
wherein:
the requestor asks the user to label chosen elements as positive or negative if each one corresponds to the refined query or does not correspond to the refined query, respectively;
the memory which receives from the user and stores the refined results having positive and/or negative labels; and
the formulator that selects certain refined results for a result set.

9. The system of claim 8, wherein the user selects a refined result from the result set as a new query.

10. The system of claim 9, wherein the search mechanism searches for results in the archive, which match the new query.

11. The system of claim 10, wherein:
a result is a video clip; and
a query is a video clip.

12. A query method comprising:
providing a query from a user;
performing a search in an archive and memory to obtain results in response to the query;
providing the results to the user to indicate whether one or more results are responsive or not responsive to the query with a positive or negative label, respectively;
selecting at least one result with a positive label;
entering the at least one result with a positive label as an additional query in the archive and memory to obtain another set of results in response to the additional query;
providing the other set of results to the user to indicate whether one or more results is responsive or not responsive to the additional query with a positive or negative label, respectively; and
formulating a final result set which compromises results from the other set of results.

13. The method of claim 12, wherein results with a negative label may be propagated to results of a corresponding negative equivalence class.

14. The method of claim 12, wherein results with labels are stored in a memory.

15. The method of claim 14, wherein results with labels stored in the memory provide information when the results are labeled in new queries.

16. The method of claim 12, wherein results of the positive equivalence classes that are the best matches to ongoing queries improve chances for getting a positive label.

17. The method of claim 12, wherein a result with a negative label is assigned to results of a corresponding negative equivalence class.

18. The method of claim 12, wherein:
a query is a video clip; and
a result is a video clip.

19. The method of claim 12, wherein labels are propagated to other unlabeled items in the archive.

20. The method of claim 12, further comprising a memory of user-provided labels of the archive data for additional queries, feedback selection of results, and/or label propagation.
